(19) United States
(12) Patent Application Publication
(10) Pub. No.: US 2019/0149778 A1
(43) Pub. Date: May 16, 2019

(54) METHOD FOR VARIABLE RECORDING OF A SCENE BASED ON SCENE CONTENT

(71) Applicant: JUNGO CONNECTIVITY LTD., Netanya (IL)

(72) Inventor: Ophir Herbst, Herzliya (IL)

(21) Appl. No.: 15/814,475

(22) Filed: Nov. 16, 2017

(51) Int. Cl. H04N 7/18; G06K 9/00; H04N 5/91; H04N 5/232

(52) U.S. Cl. CPC H04N 7/188; H04N 5/23245; H04N 5/91; G06K 9/00832

(57) ABSTRACT

A method for recording a scene, including receiving image data of the scene and recording the image data in a first mode, typically at a low rate and/or resolution. Upon detection of an event in the scene, the image data is recorded in a second mode, typically at a high rate and/or resolution. The method includes recording in multiple-modes based on multiple inputs and logic.

### FIELD

The present invention relates to the field of monitoring and recording data from a location, for example, a location including a human operator, such as a driver.

### BACKGROUND

Human error has been cited as a primary cause or contributing factor in disasters and accidents in many and diverse industries and fields. For example, traffic accidents involving vehicles are often attributed to human error and are one of the leading causes of injury and death in many developed countries. Similarly, distraction (e.g., mental distraction) of a worker affects performance at work and is one of the causes of workplace accidents.

Therefore, monitoring and recoding scenes, which include human operators, such as workers or drivers of vehicles, is an important component of accident analysis and prevention.

In-vehicle cameras, for example, dash-cams, are used to record images of drivers inside vehicles or of the external view from the car. Typically, the information gathered by the camera is saved on a local memory card that can be removed from the camera and loaded onto a computer for off-line viewing. Typically, only a limited amount of information is stored on the memory card. This information is usually not uploaded to the cloud at all due to bandwidth limitations and large video file sizes.

In some cases recording of entire scene for liability and insurance issue may be required. For example, in autonomous vehicles, it may be required to record entire drives for passenger liabilities and insurance aspects. In other cases, for security recording purposes, efficient data recording is needed.

Real-time recording of drivers by using advanced mobile telecommunication technology, has been suggested. This technology requires using specific expensive devices and is, nonetheless, restricted by signal strength and transmission bandwidth.

Event activated sensors exist, mainly to save power consumption. These sensors typically only record an event itself, and not occurrences prior to or following the event, thereby providing only partial information of the scene.

No efficient solutions for real-time recording of vehicle operators or other apparatuses or scenes, exist to date.

### SUMMARY

Embodiments of the invention provide efficient recording of data (e.g., image data) from a location, thereby reducing required storage space and enabling to upload the recorded data to the cloud or other remote device.

In embodiments of the invention, predefined events in the location are automatically detected from the data collected from the location and data recording rates and/or resolution of data are varied based on detection of the predefined event. This enables recording highly compressed variable time lapse and variable resolution data files that include the entire duration of a monitoring session, going into greater detail when an event occurs.

A method, according to an embodiment of the invention, includes receiving data from a location and recording the data in a first mode. Upon detection of an event at the location, the mode of recording is changed. Recording in a first mode may include, for example, recording data at a low rate and/or in low resolution whereas, upon detection of an event, the mode of recording is changed to an increased rate and/or resolution. Multiple recording modes may be implemented.

Thus, embodiments of the invention enable to record less detailed data of a location when no event is detected and more detailed data of the event itself, thereby reducing the overall amount of data recorded without jeopardizing the recording and monitoring of actual events.

### BRIEF DESCRIPTION OF THE DRAWINGS

The invention will now be described in relation to certain examples and embodiments with reference to the following illustrative drawing figures so that it may be more fully understood. In the drawings:

FIG. 1A is a schematic illustration of a system operable according to embodiments of the invention;

FIGS. 1B and 1C are schematic illustrations of methods for recording a scene, according to embodiments of the invention;

FIG. 2 is a schematic illustration of a method for recording a scene and generating metadata, according to an embodiment of the invention;

FIG. 3 is a schematic illustration of a method for recording a scene, using a buffer memory, according to an embodiment of the invention;

FIG. 4 is a schematic illustration of a method for recording a scene using computer vision algorithms, according to an embodiment of the invention;

FIG. 5 is a schematic illustration of a method for recording a scene based on an external signal, according to an embodiment of the invention;

FIG. 6 is a schematic illustration of a system located in a vehicle and operable according to embodiments of the invention; and

FIG. 7 is a schematic illustration of a method for recording a scene using variable recording rates, according to an embodiment of the invention.

### DETAILED DESCRIPTION

Embodiments of the invention provide systems and methods for automatic recording information of occurrences at a location and creating a compressed file of the recorded data, for easy monitoring of the location.

A location may include an in-door and/or out-door space being monitored by a sensor, such as an image sensor, radar or LIDAR (Light Detection and Ranging), audio sensor and/or other suitable sensors.

In one embodiment, a sensor is used to monitor a location which includes an operator of an apparatus, for example, a vehicle or other apparatus such as a computer, home or industrial equipment and healthcare equipment. For example, a location may include the inside of a cabin of a vehicle, including the driver of the vehicle and/or occupants other or in addition to the driver.

Typically, data (e.g., image data and/or audio data) of a location received from a sensor is recorded and streamed for on-line monitoring and/or stored for off-line analysis. However, recording all of the data from the location may take up a great deal of memory storage space and/or bandwidth and may delay saving and/or sending the data to remote devices. Thus, according to embodiments of the invention, only part of the data is recorded wherein the decision which part of the data to record is based on content of the data (e.g., visual content of a scene or sound content of audio data).

Embodiments of the invention use decision logic based on events, sensors and other inputs to enable recording in multiple modes, rates and resolutions.

The content of the data may be detected by applying multiple algorithms. In one example, which is further detailed below, the content of an imaged scene may be detected using multiple methods, such as, object detection, motion detection, and applying other computer vision algorithms.

In one embodiment, the decision which portion of the data to record, is based on detecting a predefined event in the location. In one embodiment predefined events may be automatically detected from the data collected from the location, and data recording rates and/or resolution of data are varied based detection of the predefined event.

An event in the location may be a pre-determined occurrence. In one example, an event is an occurrence which may indicate or lead to a potentially unsafe situation in the operation of an apparatus. In another example, an event includes a predetermined occupancy state of a monitored space (e.g., a number of passengers in a cabin of a vehicle compared to a predetermined threshold). Events may include other occurrences, according to embodiments of the invention.

In one embodiment the event may be determined based on parameters of the apparatus (such as speed or acceleration/deceleration, e.g., a sudden stop/break of a vehicle). In another embodiment an event may be determined based on occurrences or changes occurring in an imaged scene of the location. In other embodiments an event may be determined based on the state of the operator of the apparatus, as further exemplified below.

In one embodiment of the invention, image data or data of a scene, is collected from a location by an image sensor. The mode of collecting the data (and as a result, the amount of data collected) varies based on the contents of the scene. The variably collected image data and possibly additional data describing the scene (e.g. metadata) is recorded into a single, typically compressed, data file which may be viewed for on-line and/or off-line monitoring of the location. For example, a data file of the scene (or location) may be sent to one or more remote devices that are accessible to remote users such as call centers, owners of the apparatus, employers, friends or family, who can monitor the scene substantially in real-time and call the operator and/or issue alarms to the operator and/or call for help if necessary.

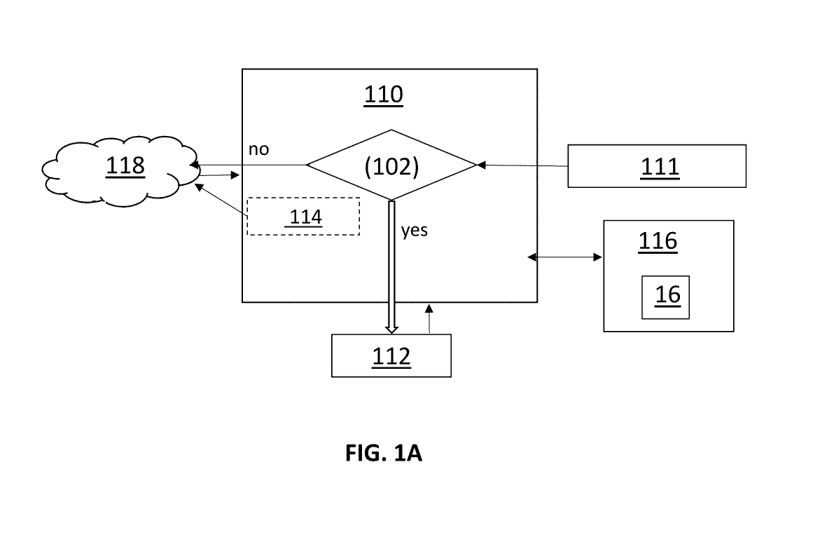

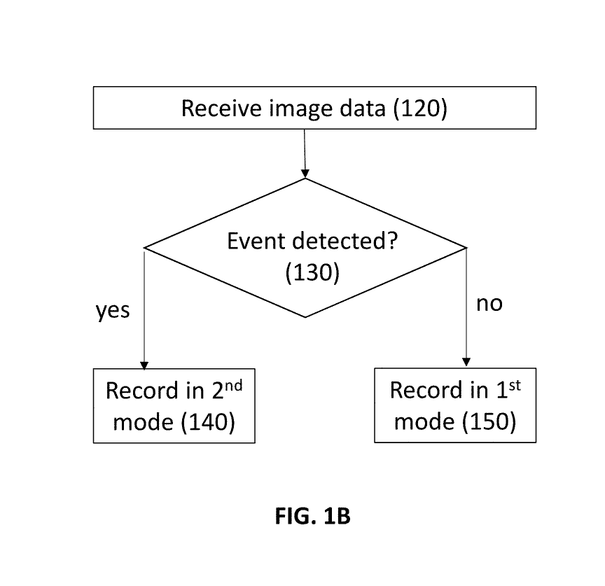

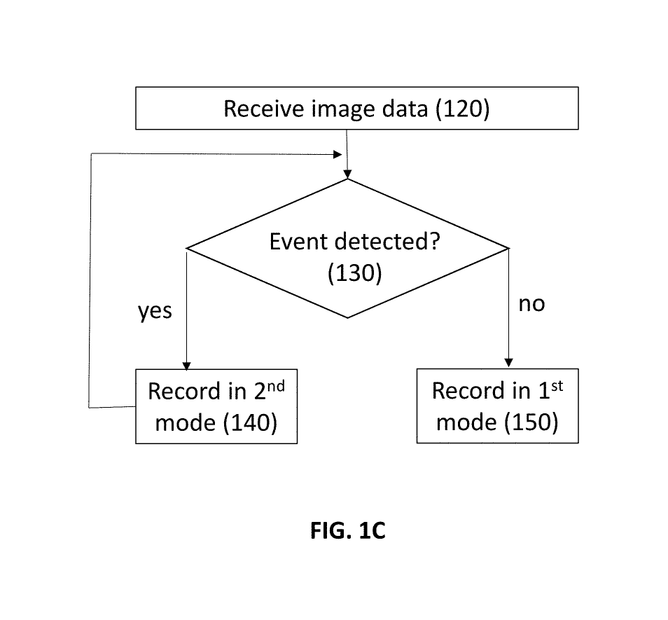

An example of a system operable according to embodiments of the invention is schematically illustrated in FIG. 1A.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” “detecting”, “identifying”, “extracting” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The system schematically illustrated in FIG. 1A includes a processing unit 110 in communication with a sensor, e.g., imager 111, to receive data, e.g., image data of the scene at the location and to record the image data in a first mode and, based on the content of the scene, change the mode of recording the image data.

In one example, the scene includes an apparatus or area of an apparatus, e.g., a vehicle or a cabin of the vehicle. In this example, an event may be a predetermined occurrence, e.g., in the cabin of the vehicle. An event may be, for example, an unsafe state of an operator of the apparatus, a medical condition of the operator, an irregular situation in the cabin of the vehicle such as violence of a passenger, non-permitted occupancy of a vehicle cabin, change in number of occupants in the vehicle cabin, etc.

In one embodiment, image data from imager 111 is collected and recorded by the processing unit 110 in a first mode and upon detection of an event (102) (e.g., a change in content of the scene and/or change in status of the apparatus) the image data from imager 111 is collected and recorded by the processing unit 110 in a second, different, mode.

Image data may include data such as values that represent the intensity of reflected light as well partial or full images or videos.

According to some embodiments, processing unit 110 generates or collects, and records metadata (114) of the recorded data. Metadata (114) may include, for example, a table mapping frames to real-world times. In addition to a time and frame map the metadata may include additional information, such as, GPS information, acceleration information and occupancy information. Additional information may be calculated from the metadata, such as, information relating to real-world times and locations and information about occupancy (e.g., number of people) at a location or a combination of information. Metadata (114), or information calculated from the metadata may also include information about object locations and resolutions, and various properties of the objects detected, sensor's unique ID, event information (e.g., duration of event, description of event, etc.), information regarding the state of the apparatus, etc. Thus, using metadata (114) enables easy search of specific events.

The data recorded in the first mode and the data recorded in the second mode are stored together, typically in a single file e.g., at a local storage device 112 and/or at remote device 118.

Imager 111 may include a CCD or CMOS or other appropriate chip. In some embodiments, the imager 111 includes a 2D or 3D camera. In one example, the imager 111 may include a standard camera provided with mobile devices such as smart phones or tablets. Thus, a mobile device such as a phone may be used to implement embodiments of the invention.

Processing unit 110 may include, for example, one or more processors and may be a central processing unit (CPU), a digital signal processor (DSP), a Graphical Processing Unit (GPU), a microprocessor, a controller, a chip, a microchip, an integrated circuit (IC), or any other suitable multi-purpose or specific processor or controller.

In some embodiments processing unit 110 is a dedicated unit. In other embodiments processing unit 110 may be part of an already existing apparatus processor, e.g., the processing unit 110 may be one core of a multi-core, possibly multi-purpose CPU already existing in an apparatus.

In one embodiment processing unit 110 is capable of detecting an event from the image data received from the imager 111 by applying image processing algorithms on the image data, such as known motion detection and shape detection algorithms and/or machine learning processes in combination with methods according to embodiments of the invention.

According to some embodiments the processing unit 110 includes or is in communication with a memory, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

In one embodiment the memory stores executable instructions that, when executed by the processing unit 110, facilitate performance of operations as follows:

Receiving data and recording the data in a first mode, e.g., recording a first portion of the data, for example, recording a certain percentage of the data and/or recording the data or part of the data at a certain resolution. Upon detection of an event (102), recording the data in a second mode. For example, recording in a second mode may include recording a different percentage of the data and/or recording the data at a different resolution.

In some embodiments processing unit 110 may apply object detection algorithms on the image data to detect specific objects (e.g., vehicles, people, etc.) and may then record the detected objects at a resolution that is different from the resolution of the rest of the image data.

The overall data recorded in both modes includes a reduced amount of data that is not of the event but detailed data of the event, thus providing a compressed data file that can be easily stored and/or transmitted. The data is recorded (in different modes) to a storage, e.g., a local storage device 112 and/or a remote device 118.

The local storage device 112, which may be, for example, removable, internal, or external storage, may include, for example, a random access memory (RAM) device, a hard disk drive (HDD), solid state drive (SSD) and/or other suitable devices.

The remote device 118 may include, for example, a server in the cloud, an external control center, a user device and/or a database which is accessible to an external user.

In some embodiments, information or portions of the information sent from the imager 111 are stored in an external database which is accessible to an external user so that the information in the database may be analyzed and used by the external user. For example, the external database may be configured to receive indications from an external user if the marking of image data, by processing unit 110, as being related to an event, is true or false. The indications may be used to update algorithms and processes at processing unit 110 to improve image analysis and detection processes.

In other embodiments, further described herein, data recorded by processing unit 110 and its metadata (114) are sent to a processing center in the cloud for monitoring and further analysis.

Processing unit 110 may be in communication with a user end device 116 that has a user interface 16. The user interface 16, typically including a screen or other display, may include buttons to enable a user to control the system (e.g., ON/OFF) and/or to enable other functions. Notices and other signals to the user may be displayed on the user interface 16.

In one embodiment user end device 116 may communicate, through processor 110, with local storage 112 and optionally with remote device 118, to obtain specific image data, based on the metadata (114) for example, based on a time and frame map.

The user end device 116 may be a stand-alone device or may be part of mobile devices such as smart phones or tablets.

In one embodiment, the user end device 116 may be a driver input unit in a vehicle, operated by the driver via a user interface that can accept input from the driver and can send a signal to processing unit 110. When starting to drive the driver may use a button on the user interface to input relevant information such as date, time, location, vehicle or apparatus ID, imager ID, etc. and/or to indicate that the vehicle is being operated. While driving, the driver may use a button on the user interface to indicate an event (e.g., if the driver feels tired).

Although the examples herein describe image data collected by an image sensor, it should be appreciated that embodiments of the invention may collect other data, such as audio data, using appropriate sensors, such as an audio sensor.

Also, although examples herein describes a driver of a vehicle, embodiments of the invention may also be practiced on human operators of machines other than vehicles, such as computers, home or industrial equipment and healthcare equipment. The terms “driver” and “driving” used in this description refer to any operator of an apparatus according to embodiments of the invention. The terms “driver” and “driving” may refer to an operator or operating of a vehicle (e.g., car, train, boat, airplane, etc.) or equipment or other apparatus.

A method for recording a scene, which is schematically illustrated in FIG. 1B, may be carried out by a processor such as processing unit 110. The method, according to an embodiment of the invention, includes the steps of receiving image data of a scene (120) and recording the image data in a first mode (150). Upon detection of an event in the scene (130) the mode of recording is changed and the image data is recorded in a second mode (140).

According to one embodiment the method includes recording metadata corresponding to the image data recorded in the first mode and second mode.

In one embodiment recording in the first mode includes recording the image data at a first rate and recording in the second mode includes recording the image data at an increased rate.

In another embodiment recording in the first mode includes recording the image data at a first resolution and recording in the second mode includes recording at least part of the image data at an increased resolution.

The part of the data recorded at an increased resolution may be specific, predefined, objects such as an operator of an apparatus, other apparatuses (e.g., vehicles), objects external to the apparatus (e.g., pedestrians), etc. In some embodiments the method includes detecting a pre-defined object in the image data, and recording the detected pre-defined object at the increased resolution. Thus, processing unit 110 may apply object detection algorithms on the image data to detect specific objects (e.g., vehicles, people, etc.) and may then record the detected objects at a resolution that is different from the resolution of the rest of the image data. The variable resolution data is recorded to a single file.

In an embodiment schematically illustrated in FIG. 1C, the method includes recording the image data in the second mode (140) for as long as the event is detected. In other embodiments the method includes recording the image data in the second mode (140) for a predetermined time after detection of the event (130).

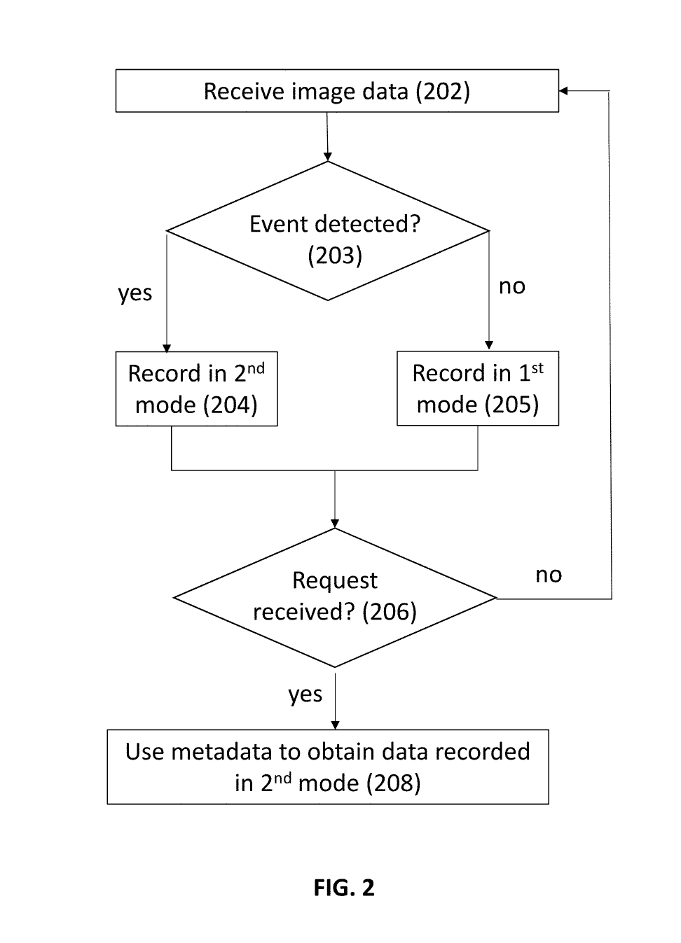

As schematically illustrated in FIG. 2, upon receiving a request, processor 110 may obtain (e.g., from the local storage 112 and/or remote device 118) the image data recorded in the second mode, based on the metadata.

Image data is received (202),e.g., from imager 111. If an event is detected (203) the data is recorded at a high rate (e.g., 30 frames per second (fps)) and/or high resolution (204). If no event is detected (203) the data is recorded at a low rate (e.g., 2 fps) and/or low resolution (205). A movie (or other file) may be created from the low rate (time lapsed) and high rate recorded data. As described above, the data file may be available for viewing. In some cases, a user reviewing the movie needs to get more detailed information of some parts of the time lapsed pat of the movie, for example, more details of an event. In these cases, the user may request to obtain the more detailed information. Upon receiving a request (206) processing unit 110 obtains the more detailed data (e.g., the data recorded in second mode) (208), typically by using the metadata.

Since the metadata includes information relating to real-world properties (e.g., real-world time and location) connected with the recorded data, by specifying, (e.g., via user end device 116), a real-world time and/or real-world location the parts of data corresponding to the specified time and/or location may be retrieved. Thus, using metadata enables easy search of specific data.

In one embodiment information may be calculated from the metadata. The information may include one or more of: real-world time, location information, event description and occupancy information. Thus, in one example, a data file (e.g., movie) created according to embodiments of the invention may be displayed with a running time line (or other icon tracking time) of the actual time of each frame shown in the movie and/or with an icon or text describing each event as it is shown in the movie and/or other descriptions of the movie, calculated from the metadata.

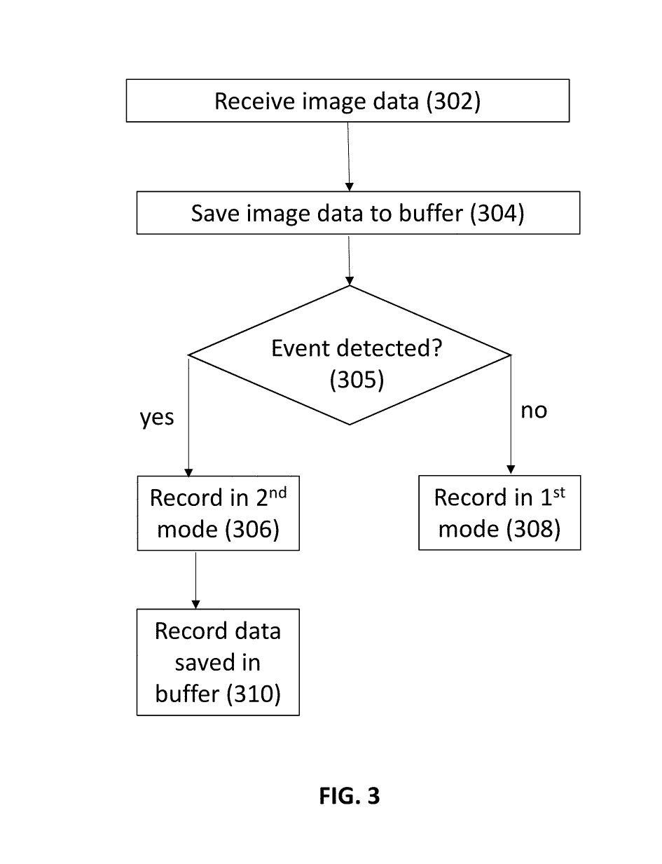

In one embodiment, which is schematically illustrated in FIG. 3, the method includes temporarily saving image data in the second mode in parallel to recording image data in the first mode, and upon detection of an event, recording the temporarily saved image data.

In one embodiment image data is received (302),e.g., from imager 111, and temporarily saved to a buffer memory (304). The data saved to the buffer memory may be data obtained at a high rate and/or resolution, for example, similar to the rate and/or resolution of recording in the second mode.

If no event is detected (305) the data is recorded, e.g., to a storage device in the first mode, i.e., at a low rate and/or low resolution (308). If an event is detected (305) the data is recorded in the second mode, i.e., at a high rate and/or high resolution (306) and the data currently in the buffer memory is recorded together with the data recorded in the second mode (310). Thus, a single file may include data of a time before an event, recorded at a low rate and/or resolution; data obtained at a high rate and/or resolution just prior to the event; and the data of the time of the event, recorded at a high rate and/or resolution

Typically, the image data is saved to the buffer memory at a high rate (e.g., at 30 fps or more), e.g., at a rate similar to the rate at which image data is recorded after an event is detected. Thus, using a buffer memory enables to maintain image data collected just prior to the event, making this data available together with data of the event, thereby providing detailed and full information of an event without needlessly taking up storage space.

Data may be maintained in the buffer memory for a predetermined time and/or may be replaced by new incoming data, dependent on the capacity of the buffer.

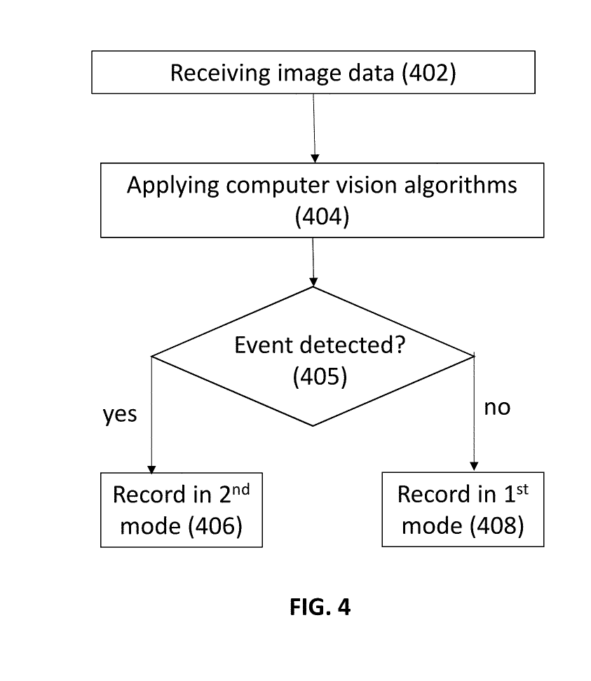

As described above, an event may be automatically detected from the data. In one embodiment, which is schematically illustrated in FIG. 4, image data is received (402),e.g., from imager 111, and computer vision algorithms are applied on the image data (404). Computer vision algorithms may include, for example, machine learning and deep learning processes, motion detection algorithms, color detection algorithms, detection of landmarks, 3D alignment, gradient detection, support vector machine, color channel separation and calculations, frequency domain algorithms and shape detection algorithms, and other appropriate algorithms.

If an event is detected (405), based on the computer vision algorithms, the data is recorded, typically to local storage 112 and/or possibly to remote device 118, in the second mode, i.e., at a high rate and/or high resolution (406). If no event is detected (405) the data is recorded, in the first mode, i.e., at a low rate and/or low resolution (408).

In some embodiments computer vision algorithms are used to count objects (e.g., people, vehicles, etc.) in a scene and an event is detected based on the number and/or change of number of objects in the scene. Thus, for example, processing unit 110 may apply a computer vision algorithm to count passengers in a cabin of a vehicle and an event may be detected (405) if a non-permitted occupancy of a vehicle cabin or a change in number of occupants in the vehicle cabin, are detected.

In some embodiments, the event is detected based on biometric parameters of a person in the scene. Biometric parameters extracted from image data of, for example, a driver, may include parameters indicative of the driver's state, such as, one or more eye gaze direction, pupil diameter, head rotation, blink frequency, blink length, mouth area size, mouth shape, percentage of eyelid closed (perclos), location of head, head movements and pose of the driver.

In one embodiment, face detection and/or eye detection algorithms may be used to detect a person's head and/or face and/or features of the face (such as eyes) from the image data. The person's head or face may then be tracked (e.g., by applying optical flow methods, histogram of gradients, deep neural networks or other appropriate detection and tracking methods) to detect head and/or eye movement.

The person's state, as indicated by the biometrics may be detected as an event.

In other embodiments, an event may be detected based on a signal received at the processing unit 110.

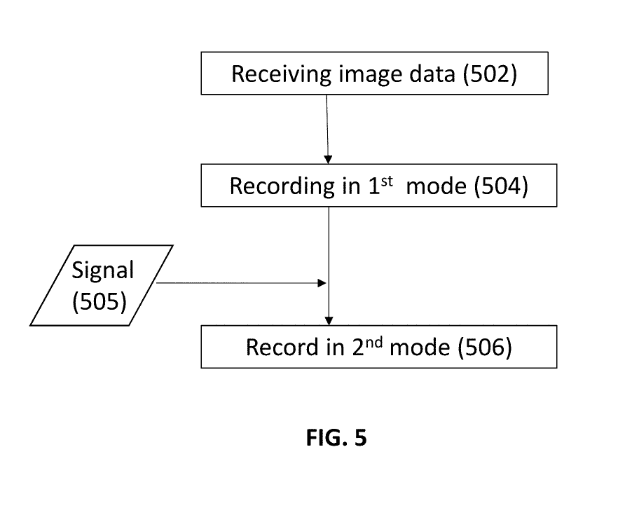

In one embodiment, an example of which is schematically illustrated in FIG. 5, the method includes receiving a signal indicating an event and detecting the event based on the signal. In one embodiment data is received (502),e.g., from imager 111, and recorded in the first mode (504). Upon receiving a signal (505) the data is recorded in the second mode (506).

In one embodiment the signal (505), which may indicate an event, may be received from an external device, such as a user operated device (e.g., user end device 116) through which user input is translated to a signal indicating an event.

In another embodiment, the signal may be received from a sensor of an apparatus parameter such as an accelerometer and/or GPS and/or speedometer and/or other suitable measuring and sensing device. For example, a sensor may include a car CAN (Controller Area Network) bus system, which may input an event such as a hard break of the car.

A sensor of apparatus parameters may be an indicator of the apparatus operation. An indicator of apparatus operation provides indication that the apparatus is in operation. For example, an indication of apparatus operation may include one or a combination of an indication of motion (e.g., if the apparatus is a vehicle), an indication of key or button pressing (e.g., if the apparatus is operated by keyboard) and change in power status of the apparatus. In some embodiments the indicator of apparatus operation may be a user operated device into which the operator (or other user) may input an indication of apparatus operation.

In one embodiment, processing unit 110 may apply motion detection algorithms on the image data obtained from image sensor 111 to receive indication of apparatus operation and/or to detect an event. In this embodiment, upon receiving a signal indicating that the apparatus is in operation, the image data is recorded in the second mode based on the detection of event and based on the signal indicating that the apparatus is in operation.

In some embodiments data is only recorded upon receiving a signal indicating that the apparatus is in operation.

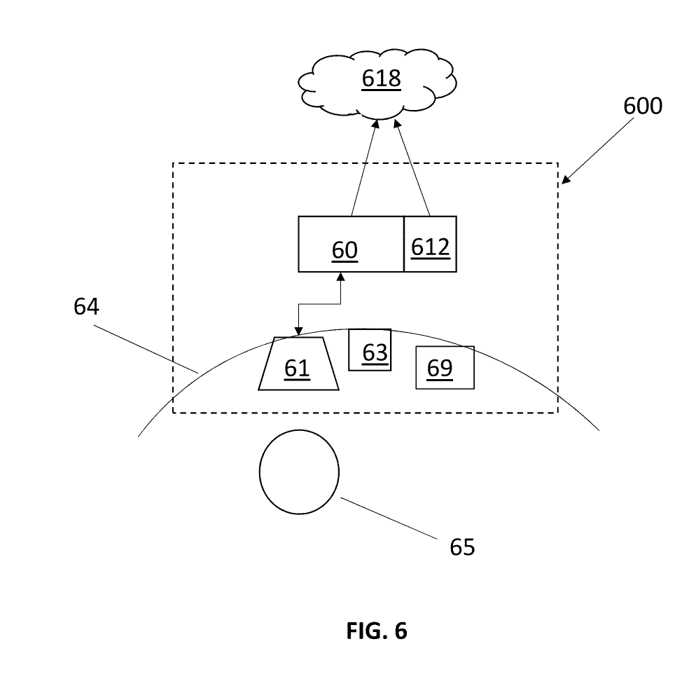

In an exemplary embodiment, which is schematically illustrated in FIG. 6, a processor and system according to embodiments of the invention, are demonstrated in connection with an apparatus (e.g., vehicle) and/or a person operating the apparatus (e.g., driver).

The system 600 includes a sensor, e.g., a camera 61 located or positioned to capture image data of a scene, which may include, for example, an area of an apparatus, e.g., vehicle 64, typically also including the operator of the apparatus, e.g., the driver 65. One or more camera(s) 61 may be positioned in vehicle 64 so as to capture images of the driver 65 or at least part of the driver 65, for example, the driver's head or face and/or the driver's eyes. For example, camera 61 may be positioned on the windshield and/or on the sun visor of the vehicle and/or on the dashboard and/or on the A-pillar and/or in the instruments cluster and/or or on the front mirror of the vehicle and/or or on a steering wheel of a vehicle or front window of a vehicle such as a car, aircraft, ship, etc.

Camera 61 includes or is in communication with a processing unit 60. Processing unit 60 is capable of detecting an event from the image data received from camera 61 by applying a computer vision algorithm on the image data to detect the event. In other embodiments processing unit 60 is capable of detecting an event by receiving a signal from an external device or sensor.

Processing unit 60 receives image data from camera 61 and records the image data in a first mode. Upon detection of an event, the processing unit 60 starts recording the data in a second, different, mode. Processing unit 60 may record the image data and/or metadata corresponding to the image data to a local storage device 612 and/or may send (on-line or off-line) the image data and/or corresponding metadata to a remote device, such as to a device on cloud 618.

In one example, an unsafe state of an operator (e.g., driver 65) or a change in the operator's state or change of occupancy in the vehicle, is detected as an event.

An operator's state refers mainly to the level of distraction of the operator. Distraction may be caused by external events such as noise or occurrences in or outside the space where the operator is operating (e.g., a vehicle), and/or by the physiological or psychological condition of the operator, such as illness, drowsiness, fatigue, anxiety, sobriety, inattentive blindness, readiness to take control of the apparatus, etc. Thus, an operator's state may be an indication of the physiological and/or psychological condition of the operator.

In some embodiments, an event may be detected based on detection of motion from the image data. Thus, motion of an operator and/or other people in the scene may cause the processing unit 60 to change the mode of recording. Similarly, lack of motion in the scene for a lengthy period of time may trigger another change in mode of recording (e.g., recording at a very low rate), as further exemplified below.

In some embodiments the system 600 includes or is in communication with one or more sensors to sense operation parameters of the apparatus, which include characteristics typical of the apparatus. For example, a motion sensor 69 may sense motion and/or direction and/or acceleration and/or location (e.g., GPS information) and/or other relevant operation parameters of the vehicle 64 thereby providing a signal indicating that the apparatus is being operated.

In some embodiments, the mode of recording image data is changed based on processing unit 60 receiving indication that the apparatus is in operation and based on detection of an event. In one example, indication is received from motion sensor 69 that the vehicle 64 is in operation, for example, if the vehicle is moving above a predetermined speed for above a predetermined time and in a predetermined direction.

In addition, based on detection of an event, processing unit 60 may generate an alarm to alert the driver and/or a signal to control a device or system associated with the vehicle such as a collision warning/avoiding system and/or infotainment system associated with the vehicle 64. In another embodiment, the command may be used to send a notification to an external control center.

In some embodiments the system 600 includes one or more illumination sources 63 such as an infra-red (IR) illumination source, to facilitate imaging (e.g., to enable obtaining image data of the driver even in low lighting conditions, e.g., at night).

All or some of the units of system 600, such as camera 61 and/or motion sensor 69 may be part of a standard multi-purpose computer or mobile device such as a smart phone or tablet.

As described above, detection of motion and/or events may cause a change in modes of recording.

In one embodiment, image data is received at a processing unit (e.g., 60) from a camera (e.g., 61) in or on a vehicle (e.g., 64). The processing unit records the received image data to a storage device (e.g., 612) in a first mode, however, upon detecting motion, the processing unit changes the mode of recording the image data to the storage device.

The motion may be motion detected from the image data and/or motion indicated by an external signal (e.g., from motion sensor 69). In one embodiment the motion is motion of the vehicle. In other embodiments the motion is motion of objects (e.g., passengers) in or in the area of the vehicle.

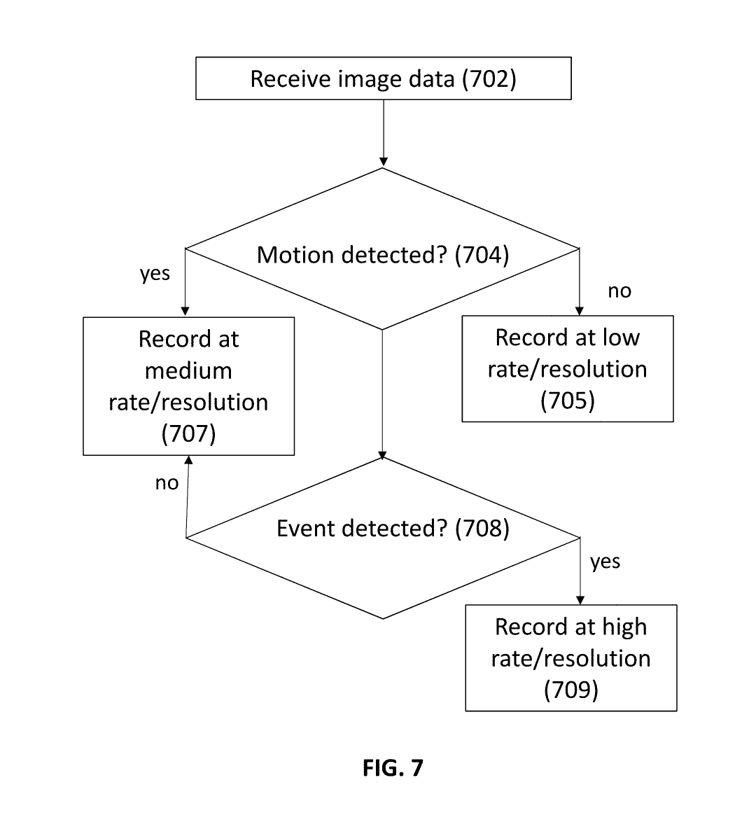

In one example, which is schematically illustrated in FIG. 7, image data is received (702), e.g., from imager 111. If no motion is detected (704),e.g., from the image data and/or from an indicator of vehicle operation, image data may be recorded at a very low rate (705), e.g., at 0.5 fps. If motion is detected (704), but no event is detected (708), image data may be recorded at a medium rate (707), e.g., at a rate of 2 fps. After detection of an event (708) the image data is recorded at a high rate (709), e.g., at a rate of 30 fps or more, in order to achieve real-time imaging and avoid missing details of the event.

In some embodiments part of the image data (e.g., specific objects such as an operator of an apparatus, other apparatuses (e.g., vehicles), objects external to the apparatus (e.g., pedestrians), etc.) may be saved at a higher resolution than the rest of the image data.

Embodiments of the invention offer an efficient and affordable way of providing detailed and full information for on-line monitoring and off-line analysis of a scene.

1. A method for recording a scene, the method comprising:
receiving, at a processor, image data of the scene;
using the processor to record the image data, to a storage device, in a first mode;
using the processor to detect an event in the scene and to record the image data, to the storage device, in a second mode, based on the detection of the event.

2. The method of claim 1 comprising using the processor to record metadata corresponding to the image data recorded in the first mode and second mode.

3. The method of claim 2 comprising, upon receiving a request at the processor, using the processor to obtain the image data recorded in the second mode, based on the metadata.

4. The method of claim 2 wherein the metadata comprises one or a combination of: time frame map, GPS information, acceleration information, and occupancy information.

5. The method of claim 2 comprising displaying on a user interface the image data recorded in the first mode, the image data recorded in the second mode and information calculated from the metadata.

6. The method of claim 1 comprising using the processor to temporarily save the image data to a buffer memory, in parallel to recording the image data in the first mode; and upon detection of an event at the processor, using the processor to record the image data from the buffer memory.

7. The method of claim 1 wherein recording in the first mode comprises recording the image data at a first rate and recording in the second mode comprises recording the image data at an increased rate.

8. The method of claim 1 wherein recording in the first mode comprises recording the image data at a first resolution and recording in the second mode comprises recording at least part of the image data at an increased resolution.

9. The method of claim 8 comprising
using the processor to detect a pre-defined object in the image data, and
recording the detected pre-defined object at the increased resolution.

10. The method of claim 1 wherein using the processor to detect the event comprises applying a computer vision algorithm on the image data to detect the event.

11. The method of claim 10 comprising detecting the event based on a number of objects in the scene.

12. The method of claim 10 comprising detecting the event based on biometric parameters of a person in the scene.

13. The method of claim 1 comprising receiving, at the processor, a signal indicating the event and detecting the event based on the signal.

14. The method of claim 1 wherein the scene includes an apparatus.

15. The method of claim 14 wherein the apparatus is a vehicle and wherein the scene comprises a cabin of the vehicle and wherein the event comprises an irregular situation in the cabin of the vehicle.

16. The method of claim 14 wherein the event comprises an unsafe state of an operator of the apparatus.

17. The method of claim 14 comprising receiving, at the processor, a signal indicating that the apparatus is in operation and recording the image data in the second mode based on the detection of the event and based on the signal.

18. The method of claim 17 wherein an indication that the apparatus is being operated comprises one or a combination of an indication of motion, an indication of key or button pressing and change in power status of the apparatus.

19. A method for recording a scene, the method comprising:
receiving, at a processor, image data from a camera associated with a vehicle;
using the processor to record the image data, to a storage device, in a first mode;
upon detecting motion, using the processor to change the mode of recording the image data to the storage device.

20. The method of claim 19 comprising detecting motion of the vehicle and changing the mode of recording the image data to the storage device, based on the detection of motion of the vehicle.
